(19) United States
(12) Patent Application Publication
(10) Pub. No.: US 2010/0023328 A1
(43) Pub. Date: Jan. 28, 2010

(54) Audio Recognition System

(76) Inventors: Paul P. Griffin, JR., Nashville, TN (US); David A. Gilbert, Nashville, TN (US); David M. Reynolds, Mt. Juliet, TN (US)

Correspondence Address: HORNKOHL INTELLECTUAL PROPERTY LAW, P.L.L.C, P.O. BOX 210584, NASHVILLE, TN, 37221, US

(21) Appl. No.: 12/510,945

(22) Filed: Jul. 28, 2009

Related U.S. Application Data
(60) Provisional application No. 61/083,987, filed on Jul. 28, 2008.

(51) Int. Cl. G10L 15/00

(52) U.S. Cl. 704/231; 704/E15.001

(57) ABSTRACT

A system and method of identifying an audio track uses music identification software that produces a fingerprint or audio profile for an audio segment recorded with a portable communication device. The audio profile is transmitted from the portable communication device to a remote service provider over a communication network. The remote server receives the transmitted audio track profile and compares the profile to a stored database of audio tracks. If a matching audio track is identified by the remote server, metadata relating to the identified audio track is transmitted from the remote server to the portable communication device. The received audio track metadata is then displayed on the portable communication device.

### CROSS-REFERENCES TO RELATED APPLICATIONS

The present invention is based upon and claims priority from co-pending U.S. Provisional Patent Application No. 61/083,987 filed Jul. 28, 2008.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

Music identification software is known. However, due to the large amount of time required to compare audio tracks and the large database of audio tracks needed to make an accurate identification, such software has not been suitable for portable electronic devices.

### BRIEF SUMMARY OF THE INVENTION

An embodiment of the present invention is directed toward a method of identifying an audio track. In accordance with the method, an audio track is recorded with a portable communication device such as a cellular telephone or digital music player. A music identification algorithm on the portable communication device is used to analyze the recorded audio track and produce an audio track profile based on the recorded audio track. The audio track profile is transmitted from the portable communication device to a remote service provider over a communication network. The transmitted audio track profile is received at the remote service provider and compared to a database of audio tracks. A matching audio track is identified in the database of audio tracks that most closely corresponds to the audio track profile. Audio track identification information corresponding to the matching audio track is retrieved. The audio track identification information is transmitted from the remote service provider to the portable communication device. The received audio track identification information is outputted on the portable communication device.

The portable communication device may contain a limited device database that is a subset of the remote service provider database selected by the user. In such an embodiment, the device attempts to identify a matching audio track in the device database of audio tracks that is stored in a memory of the portable communication device. The audio track profile is only transmitted to the remote service provider if no matching audio track is identified in the memory of the portable communication device. The device database can preferably be automatically updated over the communication network.

Another embodiment of the present invention is directed toward a system for identifying musical works. The system includes a portable electronic device having a memory, a microphone and a network connection. Music fingerprinting software is stored in the memory of the portable electronic device that produces an audio fingerprint based upon an audio segment recorded by the microphone in response to a user request. A remote service provider has a database of prerecorded musical works that is accessible by the portable electronic device over the network connection. The portable electronic device transmits the audio fingerprint to the remote service provider and the remote service provider compares the audio fingerprint to the database of prerecorded musical works, identifies a musical work in the database of prerecorded musical works that corresponds to the audio fingerprint and transmits metadata regarding the identified musical work to the portable electronic device. The metadata preferably includes a song and album title. The portable electronic device preferably includes a subset of the database of musical works stored in the memory of the portable electronic device and comparison software for determining if a match for the audio fingerprint is contained in the subset of the database of musical works prior to transmitting the audio fingerprint to the remote service provider. The subset of the database of musical works is remotely updatable via the network connection

Yet another embodiment of the present invention is directed toward a method of identifying a musical work. The method commences with the prompting of a user to record an audio segment with a portable electronic device. The audio segment is processed with software on the portable electronic device to produce an audio fingerprint based on the recorded audio segment. The audio fingerprint is compared to a device database of musical works stored on the portable electronic device to determine if any musical works in the device database match the recorded audio segment. The audio fingerprint from the portable electronic device is transmitted to a remote server over the Internet if no matching musical work is identified in the device database. The transmitted audio fingerprint is received at the remote server and compared to a remote server database of musical works to determine if any musical works in the remote server database match the recorded audio segment. Metadata for any identified matching musical works is retrieved and provided to a user of the portable electronic device.

### BRIEF DESCRIPTION OF THE SEVERAL VIEWS OF THE DRAWINGS

FIG. 1 is a block diagram of an embodiment of the present invention that identifies an audio sample using a server based database;

FIG. 2 is a block diagram of a second embodiment of the present invention that identifies an audio sample using an internal database; and

FIG. 3 is a block diagram of a third embodiment of the present invention that identifies an audio sample using an internal database and a server based database.

### DETAILED DESCRIPTION OF THE INVENTION

The invention can be implemented through software installed on any electronic device having programmable processing capabilities and a microphone or access to recorded audio segments. The software is preferably downloaded through a web interface. The invention can also be implemented through both hardware and software in the form of an accessory for a portable electronic device that contains the audio identification software and processing hardware. To identify an audio track, the accessory records an audio sample and produces a set of data points describing the audio sample. The data points can be determined based on prominent tones, melodies, beat rate, voice recognition terms or other suitable manners of statistically summarizing an audio sample. The data points are then compared to an internal database or transmitted to a remote server by the music identification accessory. The audio sample is identified based upon the set of gathered data points and a comparison to database of data points for known or popular musical works. Identifying information for any identified match is then transferred to the accessory or server as additional information related to the audio track from which the audio profile was obtained.

The music identification process of the present invention is initiated by providing a portable communication device to a consumer. A service provider is established that provides a database of prerecorded musical works. The consumer records a segment of music that is audible to the consumer in a location remote from the music identification database with the portable communication device. A music identification algorithm is made available to the operating system of the portable communication device. The portable communication device analyzes the recorded audio segment via the music identification algorithm. The portable communication device transmits the output of the music identification algorithm to a service provider that provides a music identification device over an available network connection. The music identification device analyzes and compares the transmitted output to a database of musical works. The music identification device identifies at least one closest match. The musk identification device retrieves information regarding the closest match. The music identification device transmits the retrieved information regarding the closest match to the portable communication device. The portable communication device presents the consumer with the retrieved information regarding the match.

The database of prerecorded musical works can be located in memory accessible to the portable communication device if the database of prerecorded musical works contains a limited, intelligent subset of prerecorded musical works. The intelligent subset may be selected based upon criteria such as genre of music, TV shows, artist, etc. The portable communication device determines if information regarding the output of the music identification algorithm is stored within the intelligent subset of prerecorded musical works. If the information regarding the output of the music identification algorithm is stored within the intelligent subset of prerecorded musical works, the information regarding the output of the music identification algorithm is retrieved and presented to the consumer. If the information regarding the output of the music identification algorithm is not stored in the subset of prerecorded musical works, the portable communication device transmits the output to the remote service provider over an available network connection. The music identification device then analyzes and compares the transmitted output to a central database of musical works. The subset of prerecorded musical works is remotely updatable via an available network connection to the portable communication device.

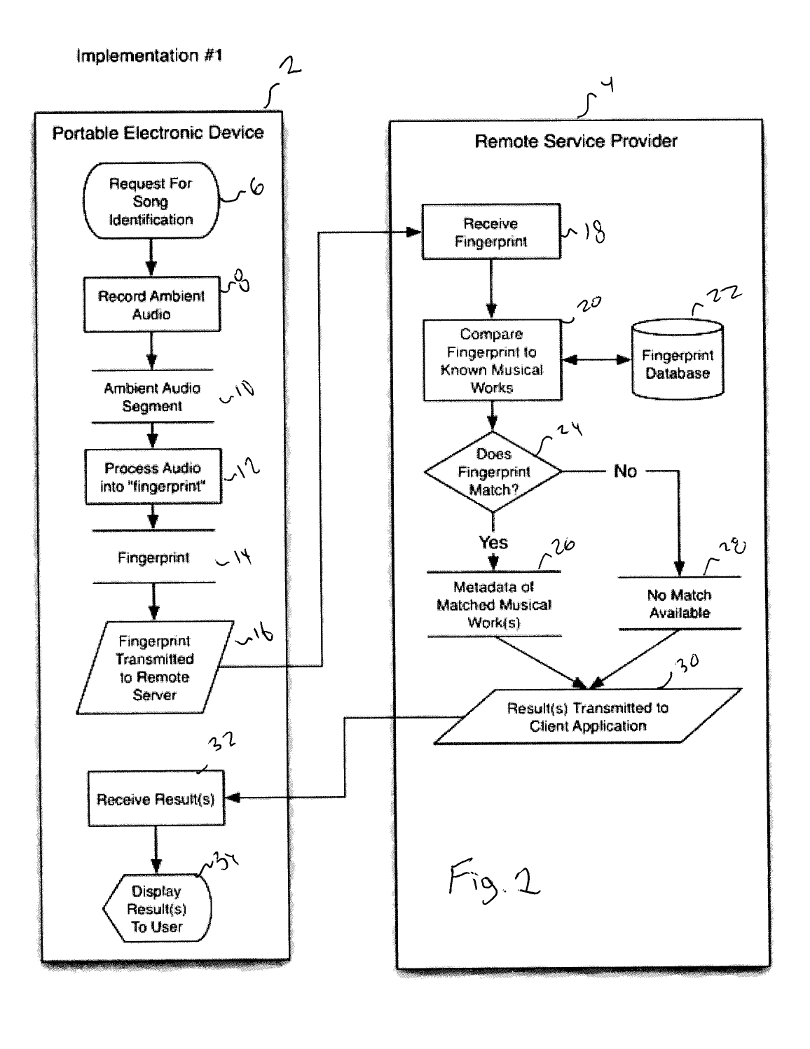

FIG. 1 is a block diagram of an embodiment of the present invention that identifies an audio sample using a server based database. The system is divided between a portable electronic device 2 and a remote service provider 4. To identify a song, a request for song identification 6 is initiated by a user of the portable electronic device 2. Once the user makes the selection, the portable electronic device 2 begins recording 8 an ambient audio segment 10, such as a music or movie sample that is audible. The audio segment is then processed 12 by a linger printing algorithm that produces a fingerprint 14 of the audio segment. An audio fingerprint is a condensed digital summary generated from an audio signal that can be used to identify the audio sample or quickly locate similar items in an audio database. The fingerprint 14 is then transmitted 16 to the remote service provider 4. By only transmitting the fingerprint 14 instead of the entire audio sample, a faster more responsive system is created.

The remote service provider 4 analyzes and compares the fingerprint 14 to identify a close match to a prerecorded musical work. The service provider 4 then returns the results of the comparison, which is displayed by the portable electronic device 2 to the user. More particularly, the remote service provider 4 receives the fingerprint 14 from the portable device 2 in block 18. The generated fingerprint 14 is then compared in block 20 to fingerprints of known musical works in a fingerprint database 22. If a fingerprint match is identified in block 24, metadata concerning the matched musical work is retrieved as shown in block 26. The metadata may be the title artist and album of the song. The service provider 4 preferably has an extensive database of information that is correlated with popular songs and audio clips.

If no match is determined in step 24, a no match available 28 message is generated. The results of the comparison are transmitted from the remote service provider 4 to the portable electronic device 2 in step 30. The transmission can be over the internet, a cellular network or other similar type communication channel. The results of the comparison are received by the portable device in step 32 and displayed to the user in step 34.

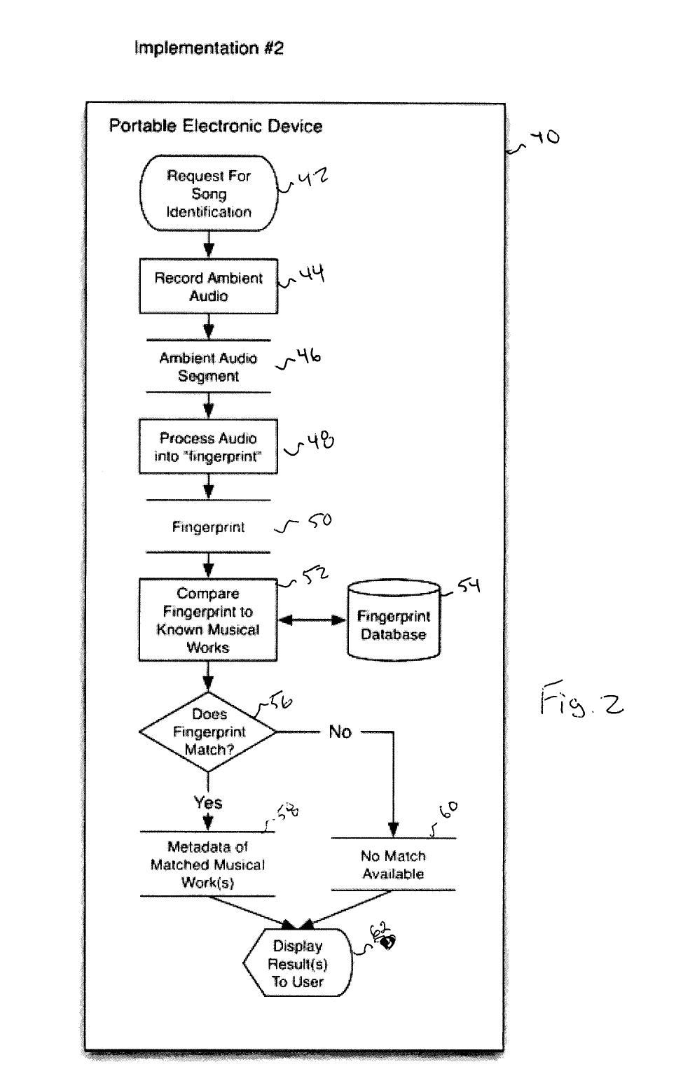

FIG. 2 is a block diagram of a second embodiment of the present invention that identifies an audio sample using an internal database. The system of FIG. 2 primarily differs from that of FIG. 1 in that the database of musical works is contained within the portable electronic device. More particularly, the music identification system of FIG. 2 begins with the electronic device 40 receiving a request for song identification in block 42. In response to the request 42, the portable electronic device 40 records ambient audio 44 and produces an ambient audio segment 46. Software stored in the device 40 then processes the audio segment 48 to produce a simplified fingerprint 50 that can more easily be compared to a database of fingerprints 54. The database 54 contains fingerprints that have been produced for known musical works. The simplified comparison of the generated fingerprint 50 to the fingerprints of known musical works 52 allows the device 40 to complete the comparison more quickly than a system that compares full audio segments. In addition, less memory storage is required by the portable device since only fingerprints of musical works are stored in the database. In step 56, the software determines if there is a match for the fingerprint 50 in the database of fingerprints 54. If a match is located, metadata for the matched musical work is retrieved 58 from the database 54 and the results are displayed to the user 62. If no match is determined in step 56, a no match available 60 message is generated and displayed to the user 62.

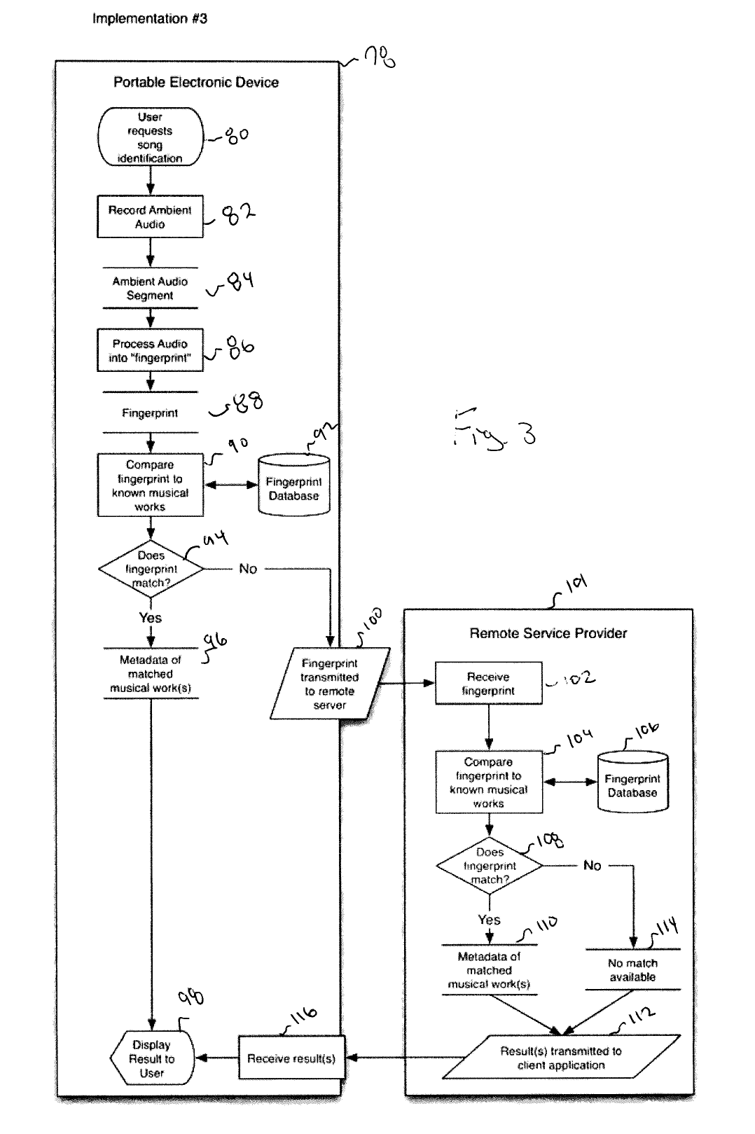

FIG. 3 is a block diagram of a third embodiment of the present invention that identifies an audio sample using a portable electronic device with an internal database and a server based database. The music identification system of FIG. 3 begins with the portable electronic device 78 receiving a request for song identification 80. In response to the request 80, the portable electronic device 78 records ambient audio 82 and produces an ambient audio segment 84. Software stored in the device 78 then processes the audio segment 86 to produce a simplified fingerprint 88 that can more easily be compared to a database of fingerprints 92. As discussed above, the database 92 contains fingerprints that have been produced for known musical works.

The fingerprint 88 is compared to the fingerprints of known musical works 90. Device software determines if there is a match for the fingerprint 88 in the device database of audio fingerprints 92. The database 92 is preferably a locally accessible, and network-updateable, database containing an intelligent subset of prerecorded musical works. If a close match is located in step 94, metadata for the matched musical work is retrieved 96 from the database 92 and the results are displayed to the user 98. However, unlike in the embodiment of FIG. 2, if no match is determined in step 94, the fingerprint is transmitted to a remote server 100 having a more complete database 106 of prerecorded musical works for further analysis.

The remote service provider 101 receives the fingerprint in block 102. The fingerprint is then compared in block 104 to fingerprints of known musical works in a remote sever provider 101 fingerprint database 106. Since the fingerprint database 106 is managed by in the remote service provider 101 and designed to be accessed by all users of the system, it is a much more extensive database 106 that can identify audio tracks that are less common than those contained in the database 92 of the portable electronic device 78. If a fingerprint match is identified in the remote service provider database 106 in block 108, metadata concerning the matched musical work is retrieved as shown in block 110. If no match is identified, a no remote service provider match available 114 message is generated. The results of the comparison are then transmitted from the remote service provider 101 to the portable electronic device 78 in step 112. The results of the comparison are received by the portable device in step 116 and displayed to the user in step 98.

Although there have been described particular embodiments of the present invention of a new and useful AUDIO RECOGNITION SYSTEM, it is not intended that such references be construed as limitations upon the scope of this invention except as set forth in the following claims.

What is claimed is:

1. A method of identifying an audio track, said method:
recording an audio track with a portable communication device;
using a music identification algorithm on said portable communication device to analyze the recorded audio track and produce an audio track profile based on said recorded audio track;
transmitting the audio track profile from the portable communication device to a remote service provider over a communication network;
receiving the transmitted audio track profile at the remote service provider;
comparing the transmitted audio track profile to a database of audio tracks;
identifying a matching audio track in said database of audio tracks that most closely corresponds to said audio track profile;
retrieving audio track identification information corresponding to said matching audio track;
transmitting the audio track identification information from said remote service provider to said portable communication device; and
outputting the received audio track identification information on said portable communication device.

2. The method of claim 1 further comprising the step of attempting to identify a matching audio track in a device database of audio tracks stored in a memory of said portable communication device wherein said audio track profile is only transmitted to said remote service provider if no matching audio track is identified in said memory of said portable communication device.

3. The method of claim 2 further comprises the step of updating said device database over said communication network.

4. The method of claim 2 wherein said device database is a subset of musical works selected based upon user input.

5. The method of claim 1 wherein said portable communication device is a cellular telephone.

6. The method of claim 1 further comprising the step of producing a no match available message if no match is located in said database of audio works.

7. A system for identifying musical works, said system comprising:
a portable electronic device having a memory, a microphone and a network connection;
music fingerprinting software stored in said memory of said portable electronic device that produces an audio fingerprint based upon an audio segment recorded by said microphone;
a remote service provider having a database of prerecorded musical works that is accessible by said portable electronic device over said network connection;
wherein said portable electronic device transmits said audio fingerprint to said remote service provider and said remote service provider compares said audio fingerprint to said database of prerecorded musical works, identifies a musical work in said database of prerecorded musical works that corresponds to said audio fingerprint and transmits metadata said identified musical work to said portable electronic device.

8. The system of claim 7 wherein said portable electronic device further comprises a subset of said database of musical works stored in said memory of said portable electronic device and comparison software for determining if a match for said audio fingerprint is contained in said subset of said database of musical works prior to transmitting said audio fingerprint to said remote service provider.

9. The system of claim 8 wherein said subset of said database of musical works is remotely updatable via said network connection

10. The system of claim 7 wherein said portable electronic device is a cellular telephone.

11. The system of claim 7 wherein said portable electronic device is a digital music player.

12. The system of claim 7 wherein said metadata includes a song title.

13. The system of claim 7 wherein said metadata includes an album title.

14. The system of claim 7 wherein said audio segment is stored in a memory of said portable electronic device.

15. A method of identifying a musical work, said method comprising:
prompting a user to record an audio segment with a portable electronic device;
processing said audio segment with software on said portable electronic device to produce an audio fingerprint based on said recorded audio segment;
comparing said audio fingerprint to a device database of musical works stored on said portable electronic device to determine if any musical works in said device database match said recorded audio segment;
transmitting the audio fingerprint from the portable electronic device to a remote server over the Internet if no matching musical work is identified in said device database;
receiving the transmitted audio fingerprint at the remote server;
comparing the transmitted audio fingerprint to a remote server database of musical works to determine if any musical works in said remote server database match said recorded audio segment;
retrieving metadata for any identified matching musical works; and
providing said metadata to a user of said portable electronic device.

16. The method of claim 15 further comprising the step of automatically updating said device database over said Internet.

17. The method of claim 15 wherein said device database is a subset of musical works selected based upon user input.

18. The method of claim 15 wherein said portable electronic device is a cellular telephone.

19. The method of claim 15 further comprising the step of producing a no match available message if no match is located in said device database or said remote server database.

20. The method of claim 15 wherein said portable electronic device is a digital music player.
